(19) United States
(12) Patent Application Publication
(10) Pub. No.: US 2006/0179663 A1
(43) Pub. Date: Aug. 17, 2006

(54) Trimmer head

(76) Inventor: David Harris, Rio Oso, CA (US)

Correspondence Address: MATTHEW J. TEMMERMAN, 423 E. STREET, DAVIS, CA, 95616, US

(21) Appl. No.: 11/059,774

(22) Filed: Feb. 16, 2005

(51) Int. Cl. B26B 7/00

(52) U.S. Cl. 30/276; 30/347

(57) ABSTRACT

A trimmer head with a cutting means rotatably attached to a protuberance is disclosed. In one embodiment, the head serves as a replacement head manufactured to substitute for an OEM trimmer head. In this embodiment, the protuberance houses a cutting means positioned such that said cutting means exits the trimmer head at approximately the same vertical position as the line or blade from the OEM head.

### BACKGROUND OF THE INVENTION

1. Field of the Invention

This invention relates to trimmer heads.

2. General Background

Trimmers are a well-known and commonly used tool in the yard or garden. The trimmer operates by rotating a cutting head at a high rate of speed. Attached to the trimmer's head are blades or monofilament trimmer line, either of which can cut through unwanted vegetation. Many times the blades or trimmer line will break, particularly when struck against hard objects.

### SUMMARY OF THE INVENTION

The present invention is a trimmer head that has blades or trimmer line rotatably attached to a protuberance on the trimmer head, providing for an increased life and effectiveness of the blade or line. In one embodiment, the trimmer head is designed as a replacement trimmer head, fitting over the OEM (original equipment manufacturer) spool housing. In this embodiment, the cutting mechanism of the replacement head is in vertical alignment with the original aperture for the cutting mechanism of the head, thereby ensuring that the debris shield blocks debris from the replacement head to the same extent that it blocked debris from the OEM head.

### BRIEF DESCRIPTION OF THE DRAWINGS

FIG. 1 is a perspective view of an installed trimmer head according to an embodiment of the present invention.

FIG. 2 is an exploded perspective view of an installed trimmer head according an embodiment of to the present invention.

FIG. 3 is a bottom view of a trimmer head according an embodiment of to the present invention.

FIG. 4 is a top view of a trimmer head according an embodiment of to the present invention.

FIG. 5 is a front view of a trimmer head according an embodiment of to the present invention.

FIG. 6 is side view of a trimmer head according an embodiment of to the present invention.

FIG. 7 is a cross section view taken along line 7-7 of FIG. 5.

FIG. 8 is a cross section view taken along line 8-8 of FIG. 4.

FIG. 9 is a cross section view taken along line 9-9 of FIG. 8.

FIG. 10 is a cross section view taken along line 10-10 of FIG. 8.

### DETAILED DESCRIPTION

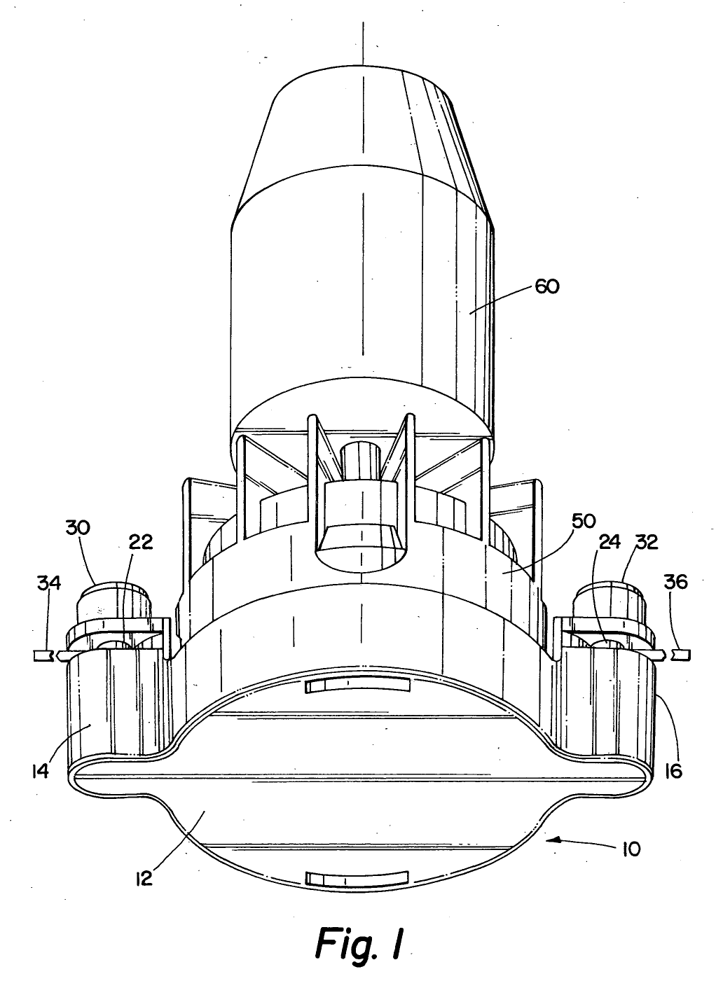

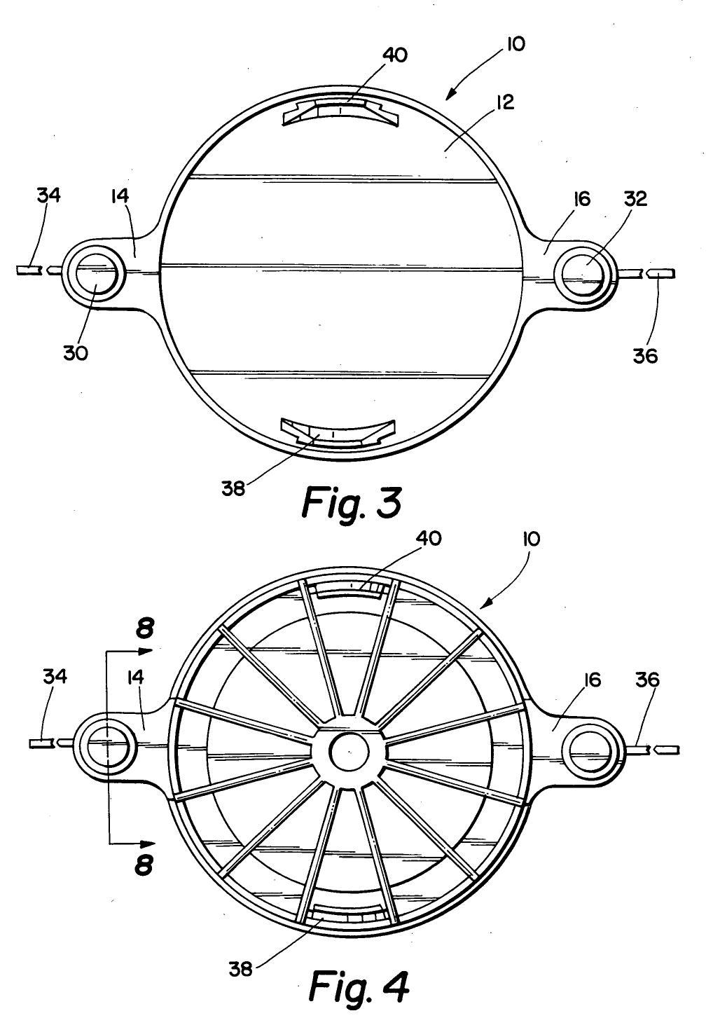

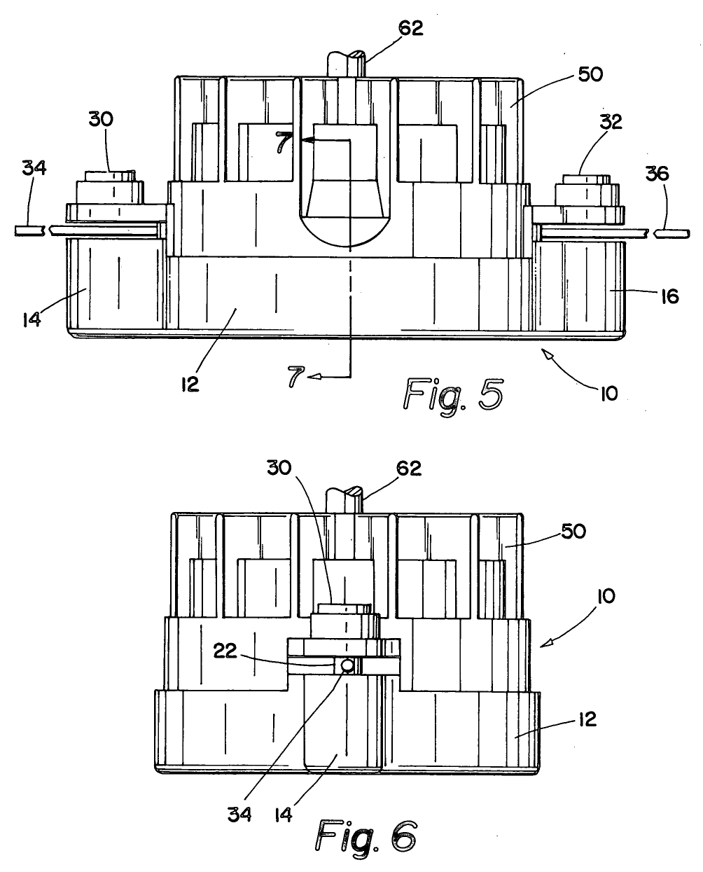

The present invention is a trimmer head 10 comprised of a body 12 with at least one protuberance and a trimmer line 34, 36 rotatably attached to the protuberance. See FIG. 1. See FIG. 1. In one embodiment, body 12 has two protuberances 14, 16 on opposing ends of the body's circumferential side, but the trimmer head may contain more or less than this number of protuberances. See FIG. 1-5. As implied by its name, the protuberance extends out from the body. In one embodiment, the protuberance extends approximately 1.9 cm from the body.

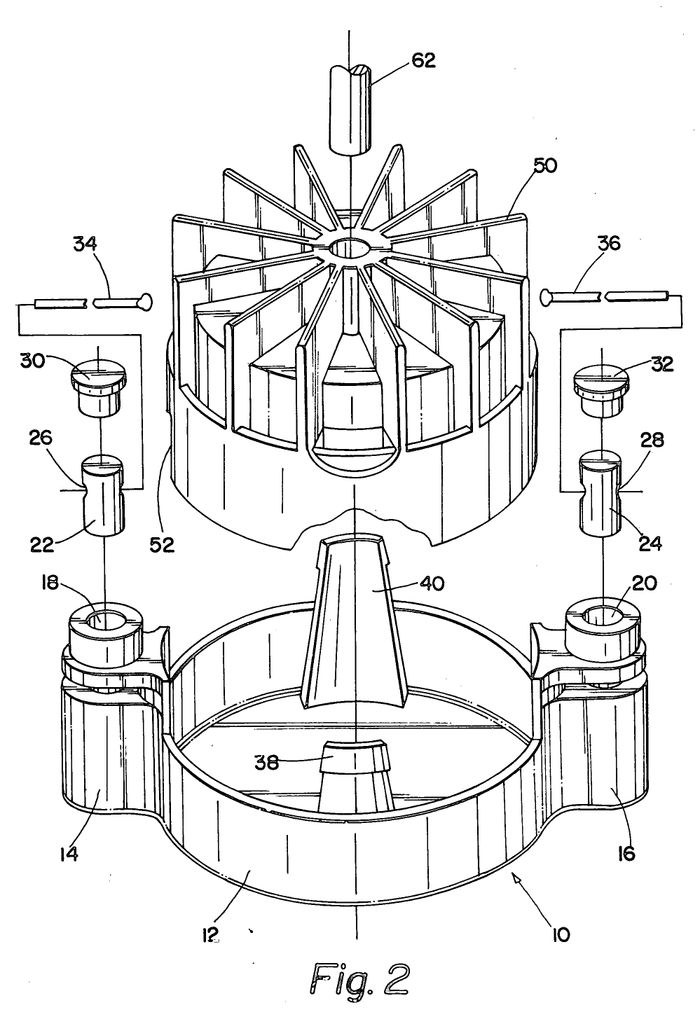

Each protuberance contains a rotating pin 22, 24 held in a pin recess 18, 20 by a rotating pin retention means 30, 32. See FIG. 2. The rotating pin 22, 24 pivotally supports a cutting means and, in one embodiment this cutting means is a fixed length of trimmer line 34, 36. See FIG. 2. An integral retaining flange at one end of the line 34, 36 secures the line in the rotating pin 22, 24 by the centrifugal force induced by the rotation of the body 12. See FIG. 2.

The rotating pin retention means 30, 32 may be a cap, plug, or other means that prevents the rotating pin 22, 24 from exiting the pin recess 18, 20 on the protuberance 14, 16. See FIG. 2. While in the pin recess 18, 20 the rotating pin 22, 24 can rotate along the same rotational axis as the drive shaft 62 of the trimmer. See FIG. 2.

In one embodiment, the device is manufactured to fit as a replacement head for an OEM trimmer head. See FIG. 1-2, 7-8. In this embodiment, the rotating pin 22 is in vertical alignment with the trimmer line aperture 52 of the spool housing 50. See FIG. 8-10. In other words, the trimmer line 34, 36 exits the rotating pin trimmer line apertures 26, 28 at roughly the same vertical plane as the trimmer line would exit the spool housing trimmer line aperture 52 in the original head. See FIG. 8-10. The protuberance 14 allows such a configuration, while keeping overall weight of the replacement head to a minimum. See FIGS. 1 and 10.

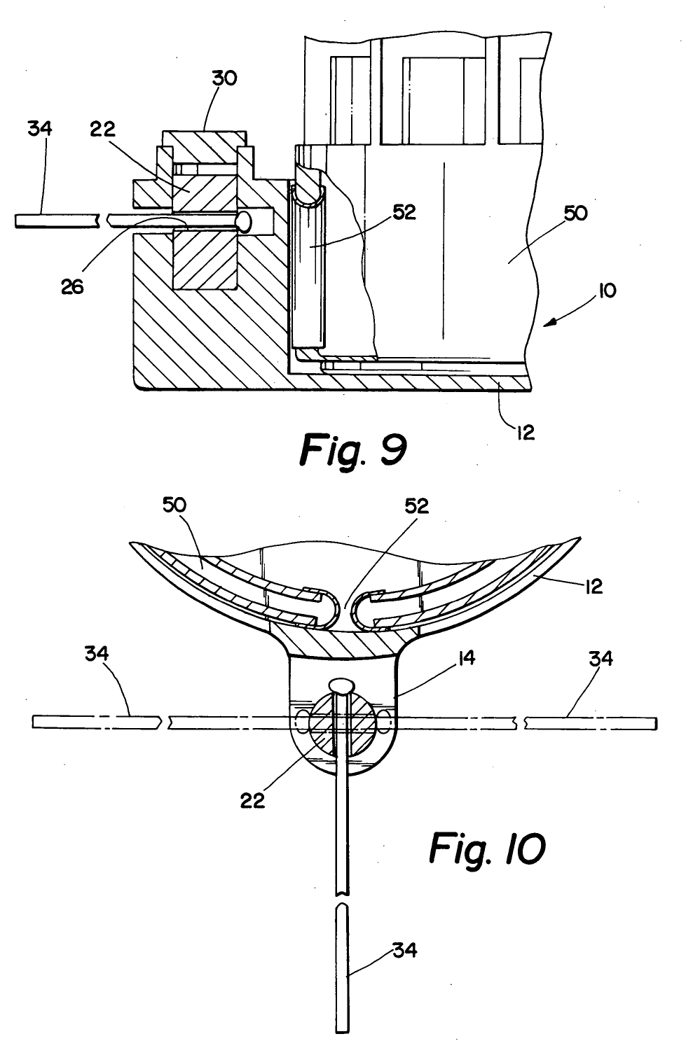

An alternative embodiment contains no protuberances but still allows the rotating pin 22 to remain in vertical alignment with the trimmer line aperture 52. See FIG. 9. In this embodiment, the entire circumferential outer edge of the body is extended radially outward so as to be even with the outermost edge of the protuberances 14, 16.

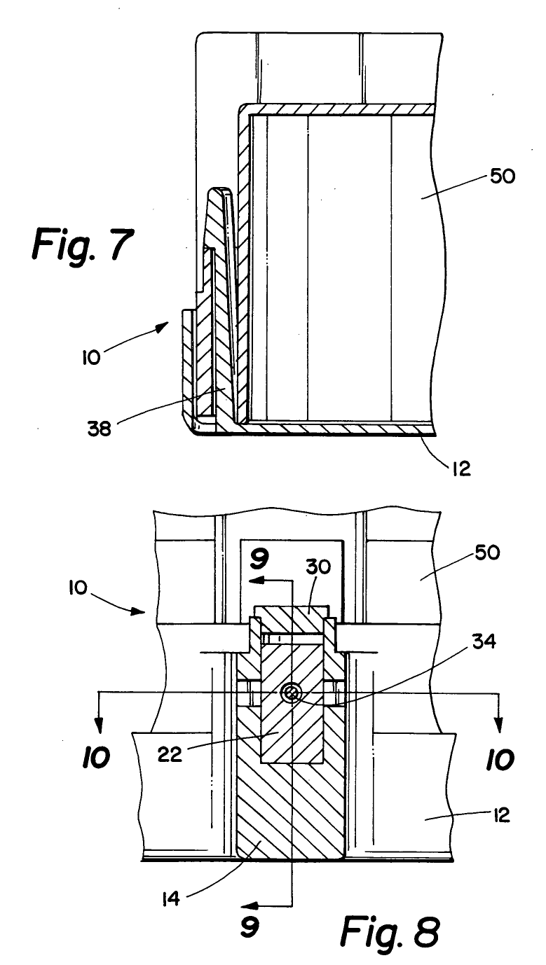

FIG. 7 is a cross section view of the replacement trimmer head 10 attached to the spool housing 50. Here, the head retention clip 38 is made from a flexible material that allows the clip to snap into the position shown in FIG. 7, tightly securing the replacement trimmer head 10 to the spool housing 50 of the original equipment manufacture trimmer head. See FIG. 7. The trimmer drive shaft 62 passes through the drive shaft housing 60 and rotates the spool housing 50. See FIG. 1-2. Because the replacement trimmer head 10 is secured to the spool housing 50, when the drive shaft 62 rotates the spool housing 50, it similarly rotates the replacement trimmer head 10. See FIG. 1-2.

One advantage of applicant's device is that the trimmer line 34, 36 is less likely to break than the trimmer line of previous trimmer heads. Because the trimmer line 34, 36, is attached to a rotating pin 22, 24, the trimmer line can swivel along the same rotational axis as the trimmer head. See FIG. 9-10. This increase in flexibility decreases the chance of line breakage and prolongs the life of the line, even when hitting an object relatively close to the rotating trimmer head. To even further increase the life and effectiveness of the line, the entire rotating pin 22, 24 assembly is housed in a protuberance 14, 16 extending radially outward from the body 12. See FIG. 10. This allows the trimmer string an even greater degree of uninhibited movement than it would have if the rotating pin 22, 24 was not placed away from the body in a protuberance.

A second advantage of applicant's device becomes apparent when the device is used as a replacement trimmer head. Specifically, the alignment between the trimmer line aperture 52 and the aperture cutting mechanism on the replacement trimmer head 10 rectifies a problem in the prior art. See FIG. 9-10. In the past, replacement trimmer heads may have extended beyond the OEM debris shield provided by the manufacturer, thereby reducing the effectiveness of the debris shield in preventing the cut vegetation from spraying on the user's leg or foot. Because the cutting mechanism of this device extends outward from substantially the same vertical plane as the original cutting mechanism of the original trimmer head, the debris shield will provide its full protection when used with the replacement trimmer head. See FIG. 9.

In one embodiment, a blade may be used in place of the trimmer line. While pivoting blades are well known in the art, they have never benefited from the advantage of being housed in a protuberance extended away from the body. The greater degree of uninhibited movement allowed to a rotatably attached string housed in a protuberance to the body is likewise granted to a blade housed in a protuberance to the body.

One skilled in the art will appreciate that the present invention can be practiced by other than the preferred embodiments, which are presented for purposes of illustration and not of limitation.

I claim:

1. A trimmer head comprising:
a. a body;
b. a protuberance extending outwardly from said body; and
c. a cutting means rotatably attached to said protuberance.

2. The trimmer head according to claim 1, wherein:
a. said trimmer head comprises a spool housing trimmer line aperture; and
b. said cutting means is in substantial vertical alignment with said spool housing trimmer line aperture.

3. The trimmer head according to claim 1, wherein:
a. said protuberance comprises a rotating pin; and
b. said cutting means is attached to said rotating pin.

4. The trimmer head according to claim 1, wherein said body comprises two protuberances.

5. The trimmer head according to claim 1, wherein said cutting means comprises a trimmer line.

6. A replacement trimmer head for attachment to an original equipment spool housing, wherein said spool housing has a spool housing trimmer line aperture, comprising:
a. a body; and
b. a cutting means attached to said body, wherein said cutting means is in substantial vertical alignment with said spool housing trimmer line aperture.

7. The trimmer according to claim 6, wherein said body comprises:
a. a protuberance extending outwardly from said body; and
b. said cutting means fastened to said protuberance.

8. The trimmer head according to claim 7, wherein said cutting means is rotatably attached to said protuberance.

9. The trimmer head according to claim 7, wherein:
a. said protuberance comprises a rotating pin; and
b. said cutting means is attached to said rotating pin.

10. The trimmer head according to claim 7, wherein said body comprises two protuberances.

11. The trimmer head according to claim 6, wherein a mounting mechanism attaches said body to said spool housing.

12. The trimmer head according to claim 11, wherein said mounting mechanism comprises a head retention clip.

13. The trimmer head according to claim 6 wherein said cutting means comprises a trimmer line.

14. A replacement trimmer head for attachment to an original equipment spool housing, wherein said spool housing has a spool housing trimmer line aperture, comprising:
a. a body with a protuberance extending outward from said body; and
b. a cutting means rotatably attached to said protuberance, wherein said cutting means is in substantial vertical alignment with said spool housing trimmer line aperture.

15. The trimmer head according to claim 14, wherein said body comprises two protuberances.

16. The trimmer head according to claim 14, wherein said cutting means comprises a trimmer line.

17. The trimmer head according to claim 14, wherein a mounting mechanism attaches said body to said spool housing.

18. The trimmer head according to claim 17, wherein said mounting mechanism comprises a head retention clip.

19. The trimmer head according to claim 14, wherein:
a. said protuberance comprises a rotating pin; and
b. said cutting means is attached to said rotating pin.

20. The trimmer head according to claim 19, wherein a rotating pin retention means prevents said rotating pin from exiting said protuberance.
